(19) United States
(12) Patent Application Publication
(10) Pub. No.: US 2003/0018598 A1
(43) Pub. Date: Jan. 23, 2003

(54) Neural network method and system

(76) Inventors: James Norman Cawse, Pittsfield, MA (US); Sanjeev Shrikrishna Tambe, Pune (IN); Bhaskar Dattatraya Kulkarni, Pune (IN)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,097

(22) Filed: Jul. 19, 2001

(51) Int. Cl. G06F 15/18; G06G 7/00; G06N 3/00; G06N 3/12

(52) U.S. Cl. 706/13; 706/1; 706/6; 706/900; 706/903

(57) ABSTRACT

A neural network construct is trained according to sets of input signals (descriptors) generated by conducting a first experiment. A genetic algorithm is applied to the construct to provide an optimized construct and a CHTS experiment is conducted on sets of factor levels proscribed by the optimized construct.

### BACKGROUND OF INVENTION

The present invention relates to a combinatorial high throughput screening (CHTS) method and system.

Combinatorial organic synthesis (COS) is an HTS methodology that was developed for pharmaceuticals. COS uses systematic and repetitive synthesis to produce diverse molecular entities formed from sets of chemical “building blocks”. As with traditional research, COS relies on experimental synthesis methodology. However instead of synthesizing a single compound, COS exploits automation and miniaturization to produce large libraries of compounds through successive stages, each of which produces a chemical modification of an existing molecule of a preceding stage. A library is a physical, trackable collection of samples resulting from a definable set of processes or reaction steps. The libraries comprise compounds that can be screened for various activities.

Combinatorial high throughput screening (CHTS) is an HTS method that incorporates characteristics of COS. The steps of a CHTS methodology can be broken down into generic operations including selecting chemicals to be used in an experiment; introducing the chemicals into a formulation system (typically by weighing and dissolving to form stock solutions), combining aliquots of the solutions into formulations or mixtures in a geometrical array (typically by the use of a pipetting robot); processing the array of chemical combinations into products and analyzing properties of the products. Results from the analyzing step can be used to compare properties of the products in order to discover “leads” formulations and/or processing conditions that indicate commercial potential.

Typically, CHTS methodology is characterized by parallel reactions at a micro scale. In one aspect, CHTS can be described as a method comprising (A) an iteration of steps of (i) selecting a set of reactants; (ii) reacting the set and (iii) evaluating a set of products of the reacting step and (B) repeating the iteration of steps (i), (ii) and (iii) wherein a successive set of reactants selected for a step (i) is chosen as a result of an evaluating step (iii) of a preceding iteration.

It is difficult to apply CHTS methodology to certain materials experiments that may have commercial application. Chemical reactions can involve large numbers of factors and require investigation of enormous numbers of factor levels (settings). For example, even a simple commercial process may involve five or six critical factors, each of which can be set at 2 to 20 levels. A complex homogeneous catalyst system may involve two, three, or even more metal cocatalysts that can synergistically combine to improve the overall rate of the process. These cocatalysts can be chosen from a large list of candidates. Additional factors can include reactants and processing conditions. The number of tertiary, 4-way, 5-way, and 6-way factor combinations can rapidly become extremely large, depending on the number of levels for each factor.

Another problem is that catalyzed chemical reactions are unpredictable. T. E. Mallouk et al. in Science, 1735 (1998) shows that effective ternary combinations can exist in systems in which no binary combinations are effective. Accordingly, it may be necessary to search enormous numbers of combinations to find a handful of “leads,” i.e., combinations that may lead to commercially valuable applications.

These problems can be addressed by carefully selecting and organizing the experimental space of the CHTS system. However in this respect, the challenge is to define a reasonably sized experimental space that will provide meaningful results.

There is a need for a methodology for specifying an arrangement of formulations and processing conditions so that synergistic interactions of chemical catalyzed reaction variables can be reliably and efficaciously detected. The methodology must provide a design strategy for systems with complex physical, chemical and structural requirements. The definition of the experimental space must permit investigation of highly complex systems.

### SUMMARY OF INVENTION

The invention provides a system and method that optimizes a CHTS experiment. In the method, a neural network construct is trained according to sets of input signals (descriptors) generated by conducting a first experiment. A genetic algorithm is applied to the construct to provide an optimized construct and a CHTS experiment is conducted on sets of factor levels proscribed by the optimized construct.

In another embodiment, training mode network input comprising descriptors and corresponding responses is stored, improved combinations of descriptors are generated from the stored network input to train a neural network construct, the neural network construct is applied to an experimental space to select a CHTS candidate experimental space and a CHTS method is conducted according to the CHTS candidate experimental space.

In a final embodiment, an experimental space is selected, a CHTS experiment is conducted on the space to produce a set of descriptors, a GA is applied on the set of descriptors to provide an improved set, a neural network construct is trained according to the improved set, a second experimental space is defined according to results from applying the construct and a second CHTS experiment is conducted on the second experimental space.

### BRIEF DESCRIPTION OF DRAWINGS

FIG. 1 is a schematic representation of a learning system;

FIG. 2 is a schematic representation of a method of conducting a CHTS experiment; and

FIG. 3 is a schematic representation of a section of one embodiment of conducting a CHTS experiment.

### DETAILED DESCRIPTION

Neural networks are massively parallel computing models of the human brain, consisting of many simple processing neurons connected by adaptive weights. A neural network construct is a set of iterative algorithmic process steps that can be embodied in a computer model. Neural networks can be used for pattern classification by defining non-linear regions in a feature space. The construct can comprise an algorithmic code simulation of a neuron model resident in a processor. The neuron model can comprise an on/off output that is activated according to a threshold level that is adjustable according to a weighted sum of inputs. The construct includes a multiplicity of neuron models, interconnected to form a network. Each model comprises an on/off output that is activated according to a threshold level that is adjustable according to a weighted sum of inputs.

Learning (training) and generalization are attributes of neural networks. The construct can be trained by adjusting a threshold level according to descriptors. Properly trained, the construct responds correctly to as many patterns as possible in a training mode that has binary desired responses. Once the weights are adjusted, the responses of the trained construct can be tested by applying various input patterns. If the network construct responds correctly with high probability to input patterns that were not included in the training mode, it is said that generalization has taken place.

According to an embodiment of the invention, a method of conducting a CHTS experiment comprises first providing and storing a training mode network input. The input can comprise descriptors corresponding to a first CHTS of the experimental space sets. The descriptors are reactants, catalysts and/or processing conditions or other factors of an experimental space. The network input can be stored in a data mart of a processor. Improved combinations of descriptors are generated from the stored network input to train a neural network construct. The neural network construct is then applied to other experimental space sets to select a CHTS candidate experimental space and a CHTS method is conducted according to the selected CHTS candidate experimental space.

Cawse, Ser. No. 09/757,246, filed Jan. 10, 2001 and titled METHOD AND APPARATUS FOR EXPLORING AN EXPERIMENTAL SPACE teaches a method of defining and applying a neural network construct to an experimental space. According to the Cawse application, the construct, called a supervised learning process, is taught according to descriptor data and concurrent experimental points developed by a genetic algorithm-processing loop. The present invention can include a neural network construct that is learned from descriptors generated from concurrently run experiments including experiments developed by a genetic algorithm processing loop. However, the current invention can optimize the neural network construct by executing a genetic algorithm on the improved combinations of descriptors from from prior art data descriptors and analysis descriptors to define an optimized neural network construct. The optimized construct is applied to an experimental space to select a CHTS candidate experimental space.

Genetic algorithms are search algorithms based on the mechanics of natural selection and natural genetics. They combine survival of the fittest among string structures with a structured yet randomized information exchange to form a search algorithm with some of the innovative flair of human search. In every generation, a new set of artificial entities (strings) is created using bits and pieces of the fittest of the old. Randomized genetic algorithms have been shown to efficiently exploit historical information to speculate on new search points with improved performance.

Genetic algorithms were developed by researchers who sought (1) to abstract and rigorously explain adaptive processes of natural systems and (2) to design artificial systems software that would retain important mechanisms of natural systems. This approach has led to important discoveries in both natural and artificial systems science The central theme of research on genetic algorithms is robustness, the balance between efficiency and efficacy necessary for survival in different environments. The implications of robustness for artificial systems are manifold. If artificial systems are made more robust, costly redesigns can be reduced or eliminated. If higher levels of adaptation can be achieved, existing systems will perform their functions longer and better.

Genetic algorithms were first described by Holland, whose book Adaptation in Natural and Artificial Systems (Cambridge, Mass.: MIT Press, 1992), is currently deemed the most comprehensive work on the subject. Genetic algorithms are computer programs that solve search or optimization problems by simulating the process of evolution by natural selection. Regardless of the exact nature of the problem being solved, a typical genetic algorithm cycles through a series of steps that can be as follows:(1) Initialization: A population of potential solutions is generated. “Solutions” are discrete pieces of data that have the general shape (e.g., the same number of variables) as the answer to the problem being solved. For example, if the problem being considered is to find the best six coefficients to be plugged into a large empirical equation, each solution will be in the form of a set of six numbers, or in other words a 1×6 matrix or linked list. These solutions can be easily handled by a digital computer.

(2) Rating: A problem-specific evaluation function is applied to each solution in the population, so that the relative acceptability of the various solutions can be assessed.

(3) Selection of parents: Solutions are selected to be used as parents of the next generation of solutions. Typically, as many parents are chosen as there are members in the initial population. The chance that a solution will be chosen to be a parent is related to the results of the evaluation of that solution: better solutions are more likely to be chosen as parents. Usually, the better solutions are chosen as parents multiple times, so that they will be the parents of multiple new solutions, while the poorer solutions are not chosen at all.

(4) Pairing of parents: The parent solutions are formed into pairs. The pairs are often formed at random but in some implementations dissimilar parents are matched to promote diversity in the children.

(5) Generation of children: Each pair of parent solutions is used to produce two new children. Either a mutation operator is applied to each parent separately to yield one child from each parent or the two parents are combined using a recombination operator, producing two children which each have some similarity to both parents. To take the six-variable example, one simple recombination technique would be to have the solutions in each pair merely trade their last three variables, thus creating two new solutions (and the original parent solutions may be allowed to survive). Thus, a child population the same size as the original population is produced. The use of recombination operators is a key difference between genetic algorithms and other optimization or search techniques. Recombination operating generation after generation ultimately combines the “building blocks” of the optimal solution that have been discovered by successful members of the evolving population into one individual. In addition to recombination techniques, mutation operators work by making a random change to a randomly selected component of the parent.

(6) Rating of children: The members of the new child population are evaluated. Since the children are modifications of the better solutions from the preceding population, some of the children may have better ratings than any of the parental solutions.

(7) Combining the populations: The child population is combined with the original parent population to produce a new population. One way to do this is to accept the best half of the solutions from the union of the child population and the source population. Thus, the total number of solutions stays the same but the average rating can be expected to improve if superior children were produced. Any inferior children that were produced will be lost at this stage. Superior children become the parents of the next generation.

(8) Checking for termination: If the program is not finished, steps 3 through 7 are repeated. The program can end if a satisfactory solution (i.e., a solution with an acceptable rating) has been generated. More often, the program is ended when either a predetermined number of iterations has been completed, or when the average evaluation of the population has not improved after a large number of iterations.

The present invention is directed to the application of an optimized neural network construct to CHTS methodology, particularly for materials systems investigation. Materials that can be investigated by the invention include molecular solids, ionic solids, covalent network solids, and composites. More particularly, materials that can be investigated include catalysts, coatings, polymers, phosphors, scintillators and magnetic materials. In one embodiment, the invention is applied to screen for a catalyst to prepare a diaryl carbonate by carbonylation. Diaryl carbonates such as diphenyl carbonate can be prepared by reaction of hydroxyaromatic compounds such as phenol with oxygen and carbon monoxide in the presence of a catalyst composition comprising a Group VIIIB metal such as palladium or a compound thereof, a bromide source such as a quaternary ammonium or hexaalkylguanidinium bromide and a polyaniline in partially oxidized and partially reduced form.

Various methods for the preparation of diaryl carbonates by a carbonylation reaction of hydroxyaromatic compounds with carbon monoxide and oxygen have been disclosed. The carbonylation reaction requires a rather complex catalyst. Reference is made, for example, to Chaudhari et al., U.S. Pat. No. 5,917,077. The catalyst compositions described therein comprise a Group VIIIB metal (i.e., a metal selected from the group consisting of ruthenium, rhodium, palladium, osmium, iridium and platinum) or a complex thereof.

The catalyst material also includes a bromide source. This may be a quaternary ammonium or quaternary phosphonium bromide or a hexaalkylguanidinium bromide. The guanidinium salts are often preferred; they include the ∀, T-bis (pentaalkylguanidinium)alkane salts. Salts in which the alkyl groups contain 2-6 carbon atoms and especially tetra-n-butylammonium bromide and hexaethylguanidinium bromide are particularly preferred.

Other catalytic constituents are necessary in accordance with Chaudhari et al. The constituents include inorganic cocatalysts, typically complexes of cobalt(II) salts with organic compounds capable of forming complexes, especially pentadentate complexes. Illustrative organic compounds of this type are nitrogen-heterocyclic compounds including pyridines, bipyridines, terpyridines, quinolines, isoquinolines and biquinolines; aliphatic polyamines such as ethylenediamine and tetraalkylethylenediamines; crown ethers; aromatic or aliphatic amine ethers such as cryptanes; and Schiff bases. The especially preferred inorganic cocatalyst in many instances is a cobalt(II) complex with bis-3-(salicylalamino)propylmethylamine.

Organic cocatalysts may be present. These cocatalysts include various terpyridine, phenanthroline, quinoline and isoquinoline compounds including 2,2′:6′,2″-terpyridine, 4-methylthio-2,2′:6′,2″-terpyridine and 2,2′:6′,2″-terpyridine N-oxide, 1,10-phenanthroline, 2,4,7,8-tetramethyl-1,10-phenanthroline, 4,7-diphenyl-1,10, phenanthroline and 3,4,7,8-tetramethy-1,10-phenanthroline. The terpyridines and especially 2,2′:6′,2″-terpyridine are preferred.

Another catalyst constituent is a polyaniline in partially oxidized and partially reduced form.

Any hydroxyaromatic compound may be employed. Monohydroxyaromatic compounds, such as phenol, the cresols, the xylenols and p-cumylphenol are preferred with phenol being most preferred. The method may be employed with dihydroxyaromatic compounds such as resorcinol, hydroquinone and 2,2-bis(4-hydroxyphenyl)propane or “bisphenol A,” whereupon the products are polycarbonates.

Other reagents in the carbonylation process are oxygen and carbon monoxide, which react with the phenol to form the desired diaryl carbonate.

These and other features will become apparent from the drawings and following detailed discussion, which by way of example without limitation describe preferred embodiments of the invention. In the drawings, corresponding reference characters indicate corresponding parts throughout the several figures.

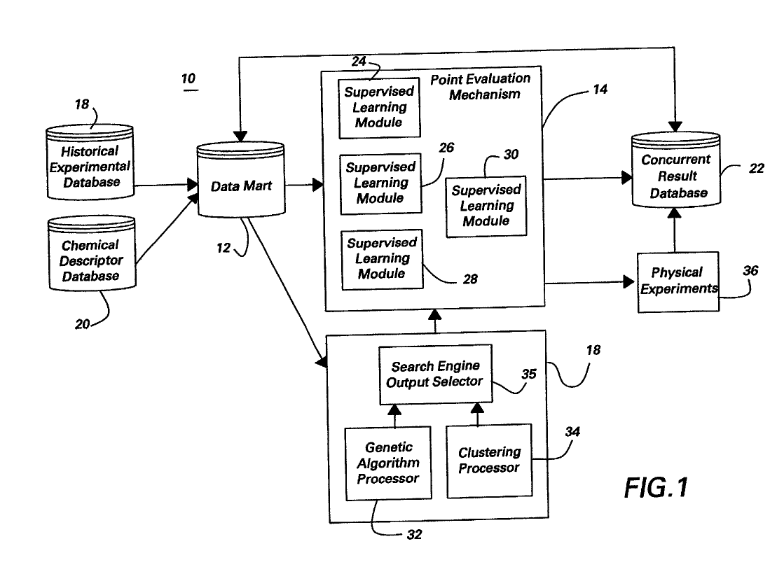

FIG. 1 shows a hybrid learning system 10. Hybrid learning system 10 includes at least a data mart 12, a point evaluation mechanism 14 and a search engine 16. Data mart 12 is a data storage element, which holds historical experimental data supplied from historical experimental database 18, chemical descriptor data from chemical descriptor database 20 and concurrent result data supplied from concurrent result database 22. Information from data mart 12 is provided to both point evaluation mechanism 14 and search engine 16. Search engine 16 supplies data to point evaluation mechanism 14, which in turn generates data for concurrent experimental result data storage 22. Each of the components of hybrid learning system 10 can be implemented as a computing device where information within the system is maintained in a computer-readable format.

Point evaluation mechanism 14 includes supervised learning modules 24, 26, 28 and a scoring/filtering module 30. Supervised learning modules 24, 26 and 28 are any neural networks known in the art including, but not limited to decision trees and regression analysis. Search engine 16 includes a genetic algorithm processor 32 and a and can include fuzzy clustering processor 34. When both are included, they function in parallel. Search engine output selector 35 can select at least one output from either processor 32 or 34, to be passed to point evaluation mechanism 30. Search engine 16 and unsupervised learning modules 24, 26, 28 supply data to scoring/filtering module 30. Information from scoring/filtering module 30 is used in determining which physical experiments 36 are to be performed. Data results from physical experiments 36 are supplied to concurrent experiment results database 22. Descriptors generated from experiments, historical data and instrumental analysis can be the input to hybrid learning system 10 as hereinafter described. Output is a defined experimental space that yields a highest selectivity and turn over number (TON) for a catalyzed chemical system.

Hybrid learning system 10 enables an efficient identification of an experimental space, such as a space for CHTS, using a neural network construct and a genetic algorithm.

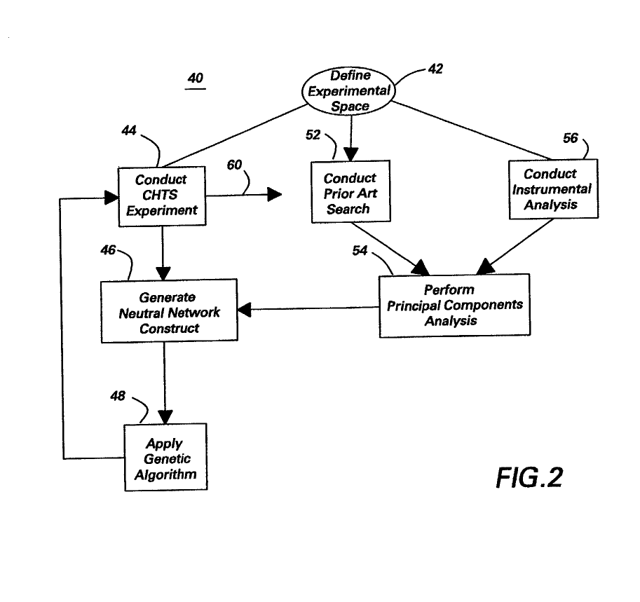

FIG. 2 is a schematic representation of a hybrid method 40 of conducting a CHTS according to the invention. In FIG. 2, an initial chemical space is prepared 42 comprising factors that are to be investigated to determine a best set of factors and factor levels. An experiment can be conducted 44 on the space to obtain a first set of results. The first set of results along with corresponding factor levels that provided the results, make up a first set of descriptors. The descriptors are stored in a data mart such as the data mart 12 of FIG. 1. A neural network construct is generated and trained 46 according to the stored first set of descriptors. While not shown in FIG. 2, in one embodiment, the descriptors can be optimized by application of a genetic algorithm prior to generating and training 46 the construct.

The network construct can be embodied in an algorithm that is resident in the point evaluation mechanism 14. A genetic algorithm is then applied 48 to the neural network construct to define an optimized neural network construct. The optimized neural network construct proscribes a new experimental space for reiterating the conducting 44 of an experiment. The loop of conducting an experiment 44, generating 46 a first neural network construct, applying 48 a genetic algorithm to optimize the construct to proscribe a new experiment can be reiterated until a goal state product is obtained 60.

Additional embodiments of the invention are shown in FIG. 2. A prior art search can be performed 52 on all or a part of an initial chemical space 42 and the results of the search analyzed according to principal component analysis (PCA) to generate 54 a more effective descriptor set. Principal component analysis (PCA) is a statistical method which permits a set of N vectors y^{μ} (points in a d-dimensional space) to be described with the aid of a mean vector <y>=1/NΣy^{N} with d principal directions and the d corresponding variances σ². PCA reduces a multi-dimensional vector described by the factor levels and results from the prior art search or from the preliminary instrumental analysis of a proposed space or from both into a relatively simple descriptor in a low dimensional space. The PCA determines the vectors that best account for the distribution of factor levels within vector sets to define a sub-space of vector sets. The sub-space selection allows the generating and training step 46 to focus on a limited set of data making up the low dimensional space.

In the invention, the PCA is applied 54 to prior art search results to generate a parsimonious descriptor set that can be added to data mart 12. The neural network construct can be generated 46 from the parsimonious descriptor set or from a combination of response data from experiment step 44 and the parsimonious descriptor set.

Additionally, instrumental analysis of components of the experimental space can be applied 56 to generate a set of data that is indicative of structural or electronic properties. For example, the data may include infrared (IR) spectra of acetylacetonate complexes of a carbonylation catalytic system. The data can be valuable for such a system since the data can represent both metal and ligand parts of the carbonylation catalyst. The data of peak positions and intensities of characteristic bands in an infrared spectrum or other analysis data can be added to prior art results. The PCA can be applied 54 to the analysis results alone or to combined analysis results and prior art search results to generate the parsimonious descriptor set that can be added to data mart 12. The neural network construct can be generated 46 from a combination of the parsimonious descriptor sets or from a combination of response data from experiment step 44 and the parsimonious descriptor sets.

During training and generalization of the construct, data is partitioned into several (e.g. 5) subsets and training is performed several times, each time using one subset as a training set and another as a test or generalizing set. If the prediction capability of the training (as measured by root-mean-square-error (RMSE) of prediction) differs beyond an acceptable limit from test set to test set, the construct will not possess good predictive power. This problem can be caused by gaps in the descriptor set such as insufficient experimental data. Additional descriptor data can be obtained for example from the prior art search. Simply adding similar (i.e. mathematically correlated) descriptor data to an existing set does not increase the information content and hence the prediction capability of the system. The data can be tested against the existing descriptor data using correlation analysis to determine if it is substantially different from the existing data.

Combining concurrent experimental descriptors and historic literary or otherwise known descriptors or descriptors from preliminary analysis can reduce dimensionality of the neural network input space. Use of prior art search and analytical data can reduce the experiment data required to train the construct. Additionally, minimizing the number of adjustable parameters in the network and developing the network with data, which is information rich, can improve generalization. A network with too many adjustable parameters will tend to model “noise” in the system as well as the data. With fewer parameters, the network will tend to average out the noise and thus conform better to the general tendency of the system. Descriptors which are simply derived from prior art will tend to be from systems unrelated to the problem at hand. The addition of experimentally derived descriptors which are more highly related to the experimental system will increase the chance that a direct relationship to the chemical phenomenon of interest (e.g. catalysis) can be found.

An improved benefit is realized when the construct is subjected to optimization by applying 48 the genetic algorithm. A neural network is fast. A neural network construct requires only a few repeat cycles to train with a CHTS experiment. However, a neural network construct flattens a response surface of the experimental space. It is best at estimating an area of best results. An experimental space in a CHTS system is marked by an extreme localization of optimum regions. Consequently, the construct may not select the best space for repeated experiment. A GA can be can be used to optimize a CHTS experiment. See Cawse, Ser. No. 09/595,005, filed Jun. 16, 2000, titled HIGH THROUGHPUT SCREENING METHOD AND SYSTEM. A GA is particularly advantageous in optimizing the types of descriptors from a CHTS experiment. In this method, the GA is directly sensitized to the localized results of the CHTS experimental space. However, optimization of the CHTS space by this method can require dozens to hundreds of generations. Cawse, Ser. No. 09/757,246, filed Jan. 10, 2001 and titled METHOD AND APPARATUS FOR EXPLORING AN EXPERIMENTAL SPACE discloses a neural network construct that is optimized by a GA iteration. This combination improves the experimental space selection.

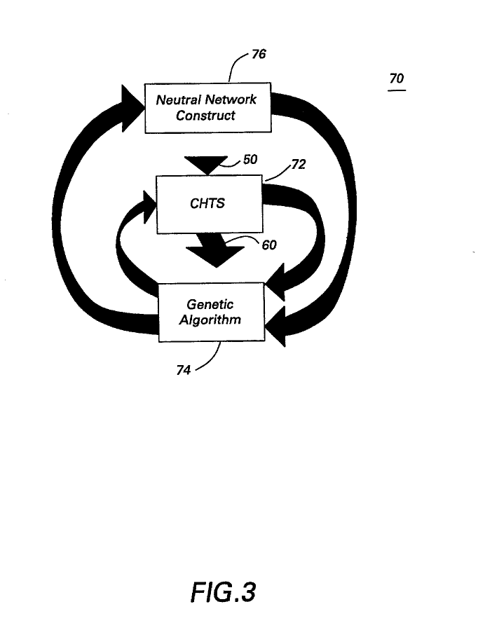

FIG. 3 illustrates a preferred embodiment of the invention. In FIG. 3, a nested cyclic methodology 70 is provided to further improve results from method 40 of FIG. 2. The arrows of FIG. 3 represent a progression from one process step shown in the FIG. 3 to another step. First, referring first to FIG. 2, a single set of CHTS data is generated 44, a neural network construct is trained and generalized 46 on the data, the construct is optimized 48 according to a GA and the optimized construct predicts 50 a new set of experiments. Then, according to FIG. 3 methodology 70, the new set 50 provides an input experimental space to CHTS experiment 72. The CHTS experiment 72 can be the same or different experiment as first experiment 64 of FIG. 2. CHTS experiment 72 generates a new set of descriptors.

The following steps are then conducted according to FIG. 3. A GA is applied 74 to improve the new descriptor set. The GA can be the same or different genetic algorithm as GA 48 of FIG. 2. A neural network construct is trained and generalized 76 according to the GA 74 improved dataset. The neural network construct that is trained and generalized 76 can start as an untrained construct or as the same neural network construct that was trained and generalized 46 according to FIG. 2. The cycle of applying the GA 74 and training 76 the construct can then be repeated for at least 2 iterations or at least 10 iterations. Preferably the cycle is repeated for 5 to 10 iterations. A final optimized descriptor set defines a final experimental space for CHTS experiment 72, which produces 60 final results.

The cycle of FIG. 3 combines the strengths of the neural network and the GA. The reiterations of construct training provide a rapid definition of a broad but highly inclusive experimental space while the reiterations of the GA cycles converge the construct definition to a highlighted space. The CHTS experiment can then convert the highlighted space at high speed to localized and detailed results that reveal leads. The overall process advantageously produces a great deal of valuable information over a broad range of chemical space at high speed. The invention permits investigation of a highly complex experimental space in 5-10 days or less. The time is substantially reduced contrasted to known procedures.

The following Example is illustrative and should not be construed as a limitation on the scope of the claims unless a limitation is specifically recited.

### EXAMPLE

An initial chemical space for a CHTS experiment is defined as the set of factors for catalyzed diphenylcarbonate reaction system shown in TABLE 1.

TABLE 1

| Role | Chemical Species | Amount |
|---|---|---|
| Catalyst | Pd(aac)2 | 25 ppm |
| Cocatalyst Metal | One or two of 19 metal | 300-500 ppm in 5 steps |
| | acetylacetonates of similar | |
| | compounds | |
| Halide Compound | Hexaethylguanadinium Bromide | 1000-5000 ppm in 5 steps |
| Solvent/Precursor | Phenol | Balance |

Seventy runs of 8550 possible runs in the system are selected at random. Each metal acetylacetonate candidate and cosolvent is made up as a stock solution in phenol. Ten ml of each stock solution are produced by manual weighing and mixing. A Hamilton MicroLab 4000 laboratory robot is used to combine aliquots of the stock solutions into individual 2-ml vials. The mixture in each vial is stirred using a miniature magnetic stirrer. The small quantity in each vial forms a thin film. The vials are loaded into a high pressure autoclave and reacted at 1000 psi, 10% CO in O2 and at 100° C. for 2 hours. The reaction content of each vial is analyzed. Results of the analysis are reported in the following TABLE 2 as catalyst turnover number, TON. TON is defined as a number of moles of aromatic carbonate produced per mole of charged catalyst.

| | | | | | Halide |
|---|---|---|---|---|---|
| Metal 1 | Amount 1 | Metal 2 | Amount 2 | Amt. | TON |
| Zr(acac)4 | 500 | none | 0 | 5000 | 700 |
| Zr(acac)4 | 400 | Snbis(acac)4Br2 | 400 | 4000 | 560 |
| Zr(acac)4 | 400 | An(acac) | 400 | 5000 | 440 |
| Zr(acac)4 | 350 | none | 0 | 2000 | 740 |
| Zn(acac) | 450 | Ir(acac)3 | 450 | 4000 | 440 |
| Yb(acac)3 | 350 | SbBr3 | 500 | 2000 | 320 |
| TiO(acac)2 | 500 | none | 0 | 5000 | 1860 |
| TiO(acac)2 | 450 | Fe(acac)3 | 400 | 1000 | 1750 |
| TiO(acac)2 | 450 | SbBr3 | 300 | 1000 | 470 |
| Snbis(acac)4B42 | 400 | Eu(acac)3 | 300 | 5000 | 550 |
| Snbis(acac)4B42 | 450 | Mn(acac)3 | 400 | 2000 | 1700 |
| Snbis(acac)4B42 | 500 | Eu(acac)3 | 500 | 4000 | 870 |
| Snbis(acac)4B42 | 400 | Eu(acac)3 | 300 | 3000 | 630 |
| Snbis(acac)4B42 | 400 | none | 0 | 5000 | 700 |
| Snbis(acac)4B42 | 500 | Rh(acac)3 | 500 | 4000 | 920 |
| Snbis(acac)4B42 | 500 | | 450 | 2000 | 240 |
| Snbis(acac)4B42 | 400 | none | 0 | 5000 | 570 |
| SbBr3 | 400 | Ni(acac)3 | 500 | 4000 | 260 |
| SbBr3 | 450 | Rh(acac)3 | 400 | 4000 | 460 |
| Ru(acac)3 | 450 | Mn(acac)3 | 500 | 5000 | 430 |
| Ru(acac)3 | 400 | none | 0 | 3000 | 1100 |
| Ru(acac)3 | 500 | Zr(acac)4 | 450 | 2000 | 300 |
| Ru(acac)3 | 350 | none | 0 | 4000 | 840 |
| Rh(acac)3 | 400 | Ir(acac)3 | 300 | 4000 | 650 |
| Rh(acac)3 | 300 | Ir(acac)3 | 500 | 5000 | 970 |
| Pb(acac)2 | 500 | none | 0 | 4000 | 1710 |
| Pb(acac)2 | 450 | SbBr3 | 400 | 4000 | 1390 |
| Ni(acac)2 | 400 | none | 0 | 3000 | 410 |
| Ni(acac)2 | 450 | Fe(acac)3 | 300 | 1000 | 90 |
| Ni(acac)2 | 350 | none | 0 | 3000 | 490 |
| Mn(acac)3 | 500 | Ce(acac)3 | 500 | 1000 | 960 |
| Mn(acac)3 | 500 | none | 0 | 3000 | 1490 |
| Mn(acac)3 | 500 | none | 0 | 1000 | 1240 |
| Mn(acac)3 | 400 | none | 0 | 1000 | 1660 |
| Ir(acac)3 | 500 | TiO(acac)2 | 450 | 2000 | 1010 |
| Ir(acac)3 | 500 | Ru(acac)3 | 400 | 3000 | 1100 |
| Ir(acac)3 | 450 | Co(acac)2 | 300 | 4000 | 930 |
| Tr(acac)3 | 450 | none | 0 | 2000 | 310 |
| Fe(acac)3 | 450 | TiO(acac)2 | 300 | 2000 | 680 |
| Fe(acac)3 | 450 | Snbis(acac)4Br2 | 300 | 1000 | 420 |
| Fe(acac)3 | 400 | none | 0 | 1000 | 1200 |
| Fe(acac)3 | 400 | none | 0 | 4000 | 1070 |
| Fe(acac)3 | 400 | none | 0 | 4000 | 1010 |
| Fe(acac)3 | 300 | Ru(acac)3 | 300 | 3000 | 610 |
| Eu(acac)3 | 500 | Ir(acac)3 | 500 | 2000 | 10 |
| Eu(acac)3 | 300 | Bi(TMHD)2 | 500 | 1000 | 320 |
| Cu(acac)2 | 400 | Zr(acac)4 | 350 | 1000 | 1250 |
| Cu(aeac)2 | 500 | Ce(acac)3 | 500 | 1000 | 650 |
| Cu(acac)2 | 450 | Zn(acac) | 300 | 1000 | 1260 |
| Cr(acac)3 | 500 | Co(acac)2 | 500 | 4000 | 320 |
| Cr(acac)3 | 500 | Bi(TMHD)2 | 300 | 2000 | 490 |
| Cr(acac)3 | 450 | Snbis(acac)4Br2 | 350 | 5000 | 630 |
| Cr(acac)3 | 450 | none | 0 | 3000 | 410 |
| Cr(acac)3 | 400 | none | 0 | 3000 | 210 |
| Cr(acac)3 | 300 | Bi(TMHD)2 | 400 | 5000 | 150 |
| Cr(acac)3 | 350 | none | 0 | 4000 | 440 |
| Co(acac)2 | 500 | Cu(acac)2 | 500 | 1000 | 1340 |
| Co(acac)2 | 500 | none | 0 | 5000 | 330 |
| Co(acac)2 | 400 | none | 0 | 4000 | 680 |
| Ce(acac)3 | 450 | Ni(acac)2 | 450 | 5000 | 2060 |
| Ce(acac)3 | 450 | none | 0 | 2000 | 1770 |
| Ce(acac)3 | 450 | none | 0 | 2000 | 570 |
| Ce(acac)3 | 400 | none | 0 | 2000 | 1930 |
| Bi(TMHD)2 | 500 | Mn(acac)3 | 500 | 5000 | 310 |
| Bi(TMHD)2 | 500 | none | 0 | 2000 | 400 |
| Bi(TMHD)2 | 450 | Zn(acac) | 450 | 5000 | 520 |
| Bi(TMHD)2 | 300 | Ni(acac)2 | 400 | 5000 | 430 |
| Bi(TMHD)2 | 350 | none | 0 | 2000 | 390 |
| Bi(TMHD)2 | 400 | none | 0 | 2000 | 300 |
| Bi(TMHD)2 | 400 | none | 0 | 1000 | 280 |

Key properties of catalyst metals are accumulated from the prior art. The properties are shown in TABLE 3. A principal components analysis indicates that the data is linearly correlated and can be reduced to two principal components without significant loss of information. The two principal components are given in columns PC1 and PC2 of TABLE 3.

TABLE 3

| Metal | EN | AR | IP | SES | SEIG | SEG | EE | ECE | EVO | PA | PC1 | PC2 |
|---|---|---|---|---|---|---|---|---|---|---|---|---|
| Bi | 1.67 | 1.7 | 7.29 | 56.7 | 908 | 186.9 | −20090 | −360.9 | −0.431 | 7.4 | 2.14 | 3.49 |
| Ce | 1.06 | 1.81 | 6.54 | 72 | 957 | 191.66 | −8563 | −196.3 | −0.337 | 29.6 | 4.12 | −1.24 |
| Co | 1.7 | 1.3 | 7.87 | 30 | 1187 | 179.41 | −1380 | −56 | −0.322 | 7.5 | −1.99 | −0.09 |
| Cr | 1.56 | 1.27 | 6.76 | 23.8 | 1050 | 174.4 | −1042 | −46 | −0.118 | 11.6 | −1.43 | −1.88 |
| Cu | 1.75 | 1.28 | 7.73 | 33.2 | 1084 | 166.4 | −1637 | −64 | −0.202 | 6.1 | −2.19 | −0.27 |
| Eu | 1.01 | 2.04 | 5.68 | 77.8 | 723 | 188.69 | −10420 | −226 | −0.233 | 27.7 | 5.39 | −1.54 |
| Fe | 1.64 | 0.68 | 719 | 27.3 | 1177 | 180.38 | −1261 | −52 | −0.295 | 8.4 | −2.81 | −0.53 |
| Ir | 1.55 | 1.36 | 9 | 35.5 | 1543 | 193.47 | −16801 | −319 | −0.335 | 7.6 | −0.57 | 3.53 |
| Mn | 1.6 | 1.26 | 7.43 | 32 | 998 | 173.6 | −1148 | −49 | −0.267 | 9.4 | −1.38 | −0.88 |
| Ni | 1.75 | 1.24 | 7.63 | 29.9 | 1167 | 182.08 | −1505 | −60 | −0.349 | 6.8 | −1.92 | 0.01 |
| Pb | 1.55 | 1.75 | 7.417 | 64.8 | 911 | 175.38 | −19519 | −354 | −0.142 | 6.8 | 2.16 | 2.65 |
| Rh | 1.45 | 1.34 | 7.46 | 31.5 | 1276 | 185.7 | −4683 | −131 | −0.239 | 8.6 | −0.91 | −0.10 |
| Ru | 1.42 | 1.33 | 7.37 | 28.5 | 1355 | 186.4 | −4483 | −126 | 0.21 | 9.6 | −1.19 | −1.37 |
| Sb | 1.82 | 1.5 | 8.641 | 45.7 | 1096 | 180.2 | −6310 | −160 | −0.186 | 6.6 | −1.08 | 1.48 |
| Sn | 1.72 | 1.5 | 7.344 | 51.2 | 1011 | 168.49 | −6020 | −156 | −0.144 | 7.7 | −0.33 | 0.33 |
| Ti | 1.32 | 1.45 | 6.82 | 30.7 | 1127 | 180.3 | −847 | −39 | −0.17 | 14.6 | −0.39 | −2.23 |
| Yb | 1.06 | 1.93 | 6.22 | 59.9 | 754 | 173.02 | −13388 | −272 | −0.286 | 21 | 3.95 | −0.43 |
| Zn | 1.66 | 1.38 | 9.39 | 41.6 | 1037 | 160.99 | −1777 | −68 | −0.399 | 7.2 | −2.15 | 0.96 |
| Zr | 1.22 | 1.6 | 6.835 | 39 | 1251 | 181.3 | −3537 | −108 | −0.151 | 17.9 | 0.57 | −1.89 |

The coded properties in the column headings are identified as follows:

TABLE 4

| | |
|---|---|
| EN | Electronegativity |
| AR | Atomic Radius |
| IP | Ionization Potential |
| SES | Standard Entropy of the Solid |
| SEIG | Standard Enthalpy of the Ion in the Gas |
| SEG | Standard Entropy of the Gas |
| EE | Total Electronic Energy |
| ECE | Exchange Correlation Energy |
| EVO | Eigenvalue of Valence Orbital |
| PA | Polarizability of Atoms |

A neural network construct is defined with seven neurons in an input layer and one neuron in an output layer. The construct training proceeds with the inputs shown in TABLE 5.

TABLE 5

| | |
|---|---|
| 1. | PC1 for metal ion 1 |
| 2. | PC2 for metal ion 1 |
| 3. | Metal 1 to Pd ratio |
| 4. | PC1 for metal ion 2 |
| 5. | PC2 for metal ion 2 |
| 6. | Metal 2 to Pd ratio |
| 7. | Br to Pd ratio |

The neural network construct training proceeds by assembling the seven inputs for each of the 71 runs into a 71×7 virtual matrix resident within a processor. A 71×1 virtual output matrix is constructed with TON as output. The 71 runs are partitioned into training and test sets. The training set is used for adjusting network weights; the test set is used to monitor a generalization capability of the network. Variable numbers of neurons are tested for a hidden layer to determine an optimum construct for a first training of the system. The network is trained to a Root Mean Squared Error (RMSE) of 0.0917 and a correlation coefficient of 0.88 between predicted and experimental TON values. Four neurons are incorporated as the hidden layer.

The trained construct is optimized with a GA routine. The GA parameter values used in the optimization routine are given in TABLE 6.

TABLE 6

| | |
|---|---|
| Length of Chromosome | 60 |
| Population size | 30 |
| Max. no. of generations | 200 |
| Probability of cross-over | 0.95 |
| Probability of mutation | 0.01 |

The GA optimization routine produces a set of optimized formulations and the formulations are input into the CHTS experiment. The optimized feed formulations and TON results from the experiment are indicated in the following TABLE 7.

TABLE 7

| Metal 1 | Amount 1 | Metal 2 | Amount 2 | Halide Amt | TON |
|---|---|---|---|---|---|
| Zr(acac)4 | 500 | none | 0 | 5000 | 640 |
| Zr(acac)4 | 300 | none | 0 | 5000 | 710 |
| TiO(acac)2 | 500 | none | 0 | 5000 | 760 |
| TiO(acac)2 | 450 | Fe(acac)3 | 400 | 5000 | 810 |
| TiO(acac)2 | 300 | Mn(acac)3 | 350 | 5000 | 680 |
| Snbis(acac)4Br2 | 500 | TiO(acac)2 | 500 | 4000 | 840 |
| Snbis(acac)4Br2 | 400 | none | 0 | 4000 | 880 |
| Snbis(acac)4Br2 | 400 | TiO(acac)2 | 300 | 4000 | 870 |
| Ru(acac)3 | 400 | none | 0 | 4000 | 1010 |
| Ru(acac)3 | 300 | none | 0 | 4000 | 990 |
| Rh(acac)3 | 400 | Ir(acac)3 | 300 | 4000 | 1100 |
| Rh(acac)3 | 300 | Ir(acac)3 | 500 | 4000 | 1160 |
| Pb(acac)2 | 500 | none | 0 | 4000 | 1050 |
| Pb(ecac)2 | 300 | TiO(acac)2 | 350 | 3000 | 1150 |
| Mn(acac)3 | 500 | TiO(acac)2 | 450 | 3000 | 1220 |
| Mn(acac)3 | 500 | none | 0 | 3000 | 1210 |
| Mn(acac)3 | 500 | Ce(acac)3 | 500 | 3000 | 1160 |
| Mn(acac)3 | 400 | none | 0 | 2000 | 1110 |
| Ir(acac)3 | 500 | Ru(acac)3 | 400 | 2000 | 1280 |
| Ir(acac)3 | 500 | TiO(acac)2 | 450 | 2000 | 1380 |
| Ir(acac)3 | 450 | Co(acac)2 | 400 | 2000 | 1360 |
| Fe(acac)3 | 450 | TiO(acac)2 | 300 | 2000 | 1320 |
| Fe(acac)3 | 400 | none | 0 | 1000 | 1690 |
| Fe(acac)3 | 400 | TiO(aoac)2 | 300 | 1000 | 1510 |
| Fe(acac)3 | 400 | none | 0 | 1000 | 1390 |
| Cu(acac)2 | 400 | Zr(acac)4 | 300 | 1000 | 1880 |
| Co(acac)2 | 500 | Cu(acac)2 | 500 | 1000 | 1780 |
| Ce(acac)3 | 450 | Ni(acac)2 | 450 | 1000 | 2170 |
| Ce(acac)3 | 450 | TiO(acac)2 | 350 | 1000 | 1870 |

The data and results from TABLE 7 are used to retrain and regeneralize the neural network construct. The GA is applied to the construct and another set of predictions is produced. The cycle is repeated four more times, at which point no further improvement occurs. A final output is shown in TABLE 8. The TABLE 8 shows maximum TON increasing further to 2440 with an average increasing to 1600.

TABLE 8

| Metal 1 | Amount 1 | Metal 2 | Amount 2 | Halide Amt | TON |
|---|---|---|---|---|---|
| Pb(acac)2 | 400 | TiO(acac)2 | 100 | 5000 | 1210 |
| Ce(acac)3 | 400 | TiO(acac)2 | 200 | 4000 | 1700 |
| Mn(acac)3 | 400 | TiO(acac)2 | 200 | 4000 | 1860 |
| Zn(acac) | 400 | TiO(acac)2 | 100 | 5000 | 1320 |
| Ce(acac)3 | 500 | TiO(acac)2 | 100 | 5000 | 2440 |
| Cu(acac)2 | 500 | none | 0 | 4000 | 1610 |
| Mn(acac)3 | 500 | TiO(acac)2 | 200 | 5000 | 1680 |
| Zn(acac) | 500 | none | 0 | 4000 | 940 |

The results show that the invention can be used to investigate a complex experimental space and can extract meaningful results from the space in the form of leads for a catalyzed commercial process.

While preferred embodiments of the invention have been described, the present invention is capable of variation and modification and therefore should not be limited to the precise details of the Examples. The invention includes changes and alterations that fall within the purview of the following claims.

1. A method, comprising:
training a neural network construct according to descriptors generated by conducting a first experiment;
applying a genetic algorithm to the construct to provide an optimized construct; and
conducting a CHTS experiment on sets of factor levels proscribed by the optimized construct.

2. The method of claim 1, wherein the descriptors are reactant factor levels, catalyst factor levels or process factor levels.

3. The method of claim 1, wherein the descriptors are combinations of reactant factor levels, catalyst factor levels, process factor levels and experimental results.

4. The method of claim 1, further comprising:
conducting the first experiment to generate descriptors;
dividing the descriptors into a first descriptor set and a second descriptor set;
training the neural network constructed according to the first set of descriptors; and
testing a generalizing capability of the construct according to the second set of descriptors.

5. The method of claim 1, comprising training the neural network construct according to descriptors generated by a combination of a first experiment and a prior art search for known descriptors.

6. The method of claim 1, comprising training the neural network construct according to descriptors generated by a combination of a first experiment and parsimonious descriptors.

7. The method of claim 5, wherein the parsimonious descriptors are combined descriptors from a prior art search and descriptors from an instrumental analysis of a proposed experimental space.

8. The method of claim 1, additionally comprising:
conducting an instrumental analysis of factor levels to produce additional descriptors;
combining additional descriptors produced from the analysis with descriptors from a prior art search to provide a set;
performing a principal components analysis on the set to provide parsimonious descriptors; and
training the neural network construct according to descriptors generated by a combination of a first experiment and the parsimonious descriptors.

9. The method of claim 1, wherein the construct comprises an algorithmic code resident in a processor.

10. The method of claim 1, wherein the construct comprises an algorithmic code simulation of a neuron model resident in a processor.

11. The method of claim 1, wherein the construct comprises an algorithmic code simulation of a neuron model resident in a processor, the model comprising an on/off output that is activated according to a threshold level that is adjustable according to a weighted sum of inputs.

12. The method of claim 1, wherein the construct comprises a multiplicity of interconnected neuron models, each model comprising an on/off output that is activated according to a threshold level that is adjustable according to a weighted sum of inputs.

13. The method of claim 1, wherein the construct comprises a multiplicity of interconnected neuron models, each model comprising an on/off output that is activated according to a threshold level that is adjustable according to a weighted sum of inputs and the training of the construct comprises adjusting the threshold level according to the descriptors.

14. The method of claim 1, wherein the genetic algorithm comprises at least one operation selected from (i) mutation, (ii) crossover, (III) mutation and selection (iv) crossover and selection and (v) mutation, crossover and selection.

15. The method of claim 1, wherein applying the genetic algorithm comprises generating first populations of binary strings representing descriptors of the neural network construct and executing the genetic algorithm with a processor on the first populations to produce a second populations of binary strings representing an optimized construct.

16. The method of claim 1, wherein applying the genetic algorithm comprises generating first populations of binary strings representing descriptors of the neural network construct and executing the genetic algorithm with a processor on the first populations to produce a second populations of binary strings representing an optimized construct, wherein the method further comprises:
synthesizing entities by combining reactant and catalyst factor combinations and subjecting the combinations to processing factors according to the optimized construct.

17. The method of claim 1, wherein the CHTS comprises effecting parallel chemical reactions of an array of reactants according to the sets of factor levels.

18. The method of claim 1, wherein the CHTS comprises effecting parallel chemical reactions on a micro scale on reactants defined according to the sets of factor levels.

19. The method of claim 1, wherein the CHTS experiment comprises an iteration of steps of simultaneously reacting a multiplicity of tagged reactants and identifying a multiplicity of tagged products of the reaction and evaluating products after completion of a single or repeated iteration.

20. The method of claim 1, wherein the sets of factor levels include a catalyst system comprising combinations of Group IVB, Group VIB and Lanthanide Group metal complexes.

21. The method of claim 1, wherein the sets of factor levels include a catalyst system comprising a Group VIII B metal.

22. The method of claim 1, wherein the sets of factor levels include a catalyst system comprising palladium.

23. The method of claim 1, wherein the sets of factor levels include a catalyst system comprising a halide composition.

24. The method of claim 1, wherein the sets of factor levels include an inorganic co-catalyst.

25. The method of claim 1, wherein the sets of factor levels include a catalyst system that includes a combination of inorganic co-catalysts.

26. The method of claim 1, wherein conducting the CHTS experiment comprises an iteration of steps of (i) providing a set of factor levels; (ii) reacting the set and (iii) evaluating a set of products of the reacting step and (B) repeating the iteration of steps (i), (ii) and (iii) wherein a successive set of factor levels selected for a step (i) is chosen as a result of an evaluating step (iii) of a preceding iteration.

27. A method of conducting a CHTS, comprising:
(1) storing training mode network input comprising descriptors and corresponding responses;
(2) generating improved combinations of descriptors from the stored network input to train a neural network construct;
(3) applying the neural network construct to an experimental space to select a CHTS candidate experimental space; and
(4) conducting a CHTS method according to the CHTS candidate experimental space.

28. The method of claim 27, wherein the network input is stored in a data memory of a processor.

29. The method of claim 27, additionally comprising executing a genetic algorithm on the neural network construct to define an optimized neural network construct.

30. The method of claim 27, additionally comprising executing a genetic algorithm on the neural network construct to define an optimized neural network construct and applying the optimized construct to an experimental space to select a CHTS candidate experimental space.

31. The method of claim 27, additionally comprising executing a genetic algorithm on the neural network construct to define an optimized neural network construct and applying the optimized construct to an experimental space to select a CHTS candidate experimental space and reiterating the steps (1) through (4) until a best result is obtained from the CHTS method of step (4).

32. A method, comprising:
selecting an experimental space
conducting a CHTS experiment on the space to produce a set of descriptors;
applying a GA on the set of descriptors to provide an improved set;
training a neural network construct according to the improved set;
defining a second experimental space according to results from applying the construct; and
conducting a second CHTS experiment on the second experimental space.

33. The method of claim 32, comprising applying a second GA to results from applying the construct.

34. The method of claim 32, comprising applying a second GA to results from applying the construct and reiterating training the neural network construct and applying the second GA for at least 2 cycles.

35. The method of claim 32, comprising applying a second GA to results from applying the construct and reiterating training the neural network construct and applying the second GA for at least 10 cycles.

36. The method of claim 32, comprising applying a second GA to results from applying the construct and reiterating training the neural network construct and applying the second GA for 5 to 10 cycles.
